(19) United States
(12) Patent Application Publication
(10) Pub. No.: US 2017/0187266 A1
(43) Pub. Date: Jun. 29, 2017

(54) ELECTRIC MACHINE WITH COMMUTATING BRUSHES

(71) Applicant: Robert Bosch GmbH, Stuttgart (DE)

(72) Inventors: Andras Paroczi, Budapest (HU); Andreas Lienig, Sinzheim (DE); Bettina Straub, Buehl Eisental (DE); Dietrich Eckstein, Kappelrodeck (DE)

(21) Appl. No.: 15/313,612

(22) PCT Filed: Apr. 14, 2015
(86) PCT No.: PCT/EP2015/058021

§ 371 Date: Nov. 23, 2016

(30) Foreign Application Priority Data
May 27, 2014 (DE) 102014210148.4

(51) Int. Cl. H02K 11/02; H02K 11/026; H02K 23/66

(52) U.S. Cl. CPC H02K 11/02; H02K 23/66; H02K 11/026

(57) ABSTRACT

The invention relates to an electric machine (10) with commutating brushes (12) and an electric interference-suppression component (14). The brushes (12) are arranged in an annular brush support (18), and the brush support (18) sits on an axial end (22) of a housing part (24) of the electric machine (10), which is preferably a pole housing (240). The interference-suppression component (14) is arranged radially outside of the housing (24), and the brush support (18) has a protrusion (30) which extends in the radial direction (2). The protrusion (30) extends radially towards the outside so as to extend outside of the housing (24), the interference-suppression component (14) being arranged on the protrusion (30).

### BACKGROUND OF THE INVENTION

The invention starts out from an electric machine that is commutated mechanically by means of an arrangement of brushes adjoining a commutator and with an interference-suppressing component.

Electric machines that are operated with direct current require a commutation of the direct current in order to generate a rotation of the rotor. This commutation can be effected by a mechanical arrangement of a commutator and a pair of brushes. Such a mechanical commutation generates abrupt interruptions of the direct current of the electric machine that is fed in. These abrupt interruptions of the direct current generate, in turn, intense electromagnetic disturbances of the entire electric machine, which are generated by voltage spikes and current ripples, for example. It s a question of reducing these electromagnetic influences. For the purpose of reducing the electromagnetic influences, interference-suppressing components are employed. The interference-suppressing components are electrically contacted with the brushes. In DE 36 29 634 A1 a brush-holder is presented, on which interference-suppressing components are arranged. This brush-holder is arranged on a field frame of an electric machine. The interference-suppressing components are consequently arranged in the immediate vicinity of the brush/collector arrangement, and also of the armature coils. By virtue of this spatial proximity, the interference-suppressing components are unable to develop their full interference-suppressing action, since electromagnetic influences of the brush/collector arrangement and of the armature coils influence the interference-suppressing components and consequently trigger negative effects that result in a lower efficiency in connection with the reduction of electromagnetic influences on the electric machine.

### SUMMARY OF THE INVENTION

The electric machine according to the invention has the advantage, in comparison with the state of the art, that the interference-suppressing components can develop their full interference-suppressing action unhindered. To this end, an interference-suppressing component is arranged radially outside a housing of the electric machine on which an annular brush-carrier is arranged. In addition, the brush-carrier is also arranged outside a housing part of the electric machine which is preferentially a field frame. Consequently the interference-suppressing component is as far away from the brushes as possible. It is possible to arrange further additional components outside the housing part. A further advantageous configuration exhibits an appendage extending in the radial direction of the brush-carrier, so that the appendage extends outside the housing. The interference-suppressing component is arranged on this appendage seated outside the housing. The interference-suppressing component may have been glued, clipped, screwed and/or riveted on. This arrangement guarantees a mechanically secure positioning of the interference-suppressing component outside the housing part.

It is possible to construct the interference-suppressing component as an individual separate capacitor. Chokes, electronic components, semiconductor components and/or inductive components are also possible by way of interference-suppressing components, besides capacitors. Consequently it can be ensured that the highest possible efficiency in connection with the reduction of electromagnetic influences on the electric machine is obtained.

If the appendage has been constructed as a plug socket with contact pins, the appendage may serve simultaneously as a mount for the interference-suppressing component and as an interface for the electric machine. A further advantage of the design of the appendage as a plug socket is the possibility of connecting the interference-suppressing component directly to the contact pins of the plug socket. Consequently, complicated wiring for a contacting of the interference-suppressing component with the brushes can be avoided. The contact pins are preferentially electrically connected to the brushes by means of conventional stamped sheet-metal strips. The stamped sheet-metal strips can be positively inserted into the brush-holder as inserts. It is also possible to encapsulate the inserts with the material of the brush-holder by injection molding.

In a further detailed specification, the interference-suppressing component is contacted with the contact pins and/or with the stamped sheet-metal strip by material closure by means of soldering or welding, and/or non-positively by means of crimping. These bonding techniques guarantee an electrical contact, which on the one hand is low-resistance and on the other hand is mechanically stable, between the interference-suppressing component and the brushes. In an advantageous embodiment, the appendage is integrally formed with the brush-holder. In this case the appendage has preferentially been attached by injection molding. This guarantees a mechanically stable and, at the same time, inexpensive construction of a brush-carrier with an appendage. The interference-suppressing component may have been arranged on the outside of the appendage, so that the interference-suppressing component is not completely enclosed by the appendage, but it may also have been encapsulated by the material forming the appendage by injection molding. Such an encapsulated interference-suppressing component offers the advantage of a secure positioning of the interference-suppressing component.

The brush-carrier expediently exhibits a bearing seat for an armature shaft, so that the brush-carrier performs a multiple function as a bearing for the armature shaft and for the brushes. This guarantees a small number of components to be mounted for the completion of the electric machine.

The entire brush-carrier with the appendage is preferentially a plastic injection-molded part. Plastic injection-molded parts can be manufactured inexpensively.

The electric machine according to the invention can be used as an adjusting drive in an automobile, for example as a window regulator, sunroof, trunk-hatch drive, seat-adjusting drive and/or drive of a manual transmission. The use of such an electric machine according to the invention has the advantage of reliable performance.

### BRIEF DESCRIPTION OF THE DRAWING

An embodiment of the invention is represented in the drawing and elucidated in more detail in the following description.

Shown is:

FIG. 1: an electric machine with a brush-carrier according to the invention, which exhibits a plug socket with an interference-suppressing component arranged thereon.

### DETAILED DESCRIPTION

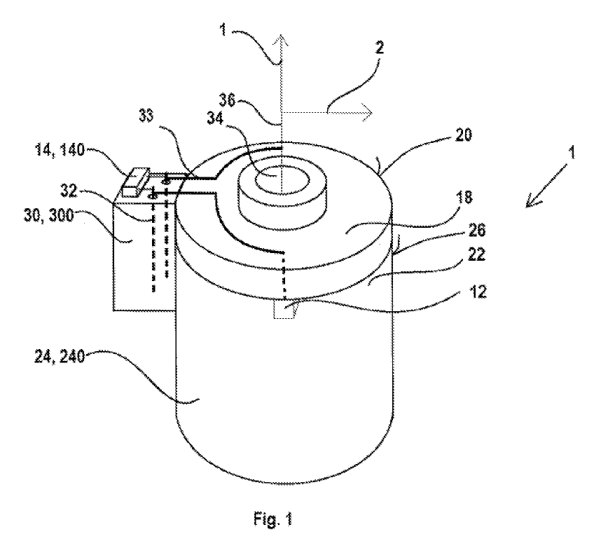

An electric machine 10 according to the invention is shown in FIG. 1. The electric machine 10 includes a housing part 24 which is constructed as a field frame 240. At an axial end 22 a brush-holder 18 rests on the field frame 240 adjacently in the axial direction 1. The brush-carrier 18 is of annular configuration. On the side of the brush-carrier 18 facing toward the field frame 240 a pair of brushes 12 are arranged. In addition, the brush-carrier 18 includes an armature-shaft bearing seat 34. The armature-shaft bearing seat 34 is arranged in the axial direction 1 on the opposite side of the brush-carrier 18 with respect to the brushes 12. The bearing seat 34 is an annular appendage integrally formed with the brush-holder 18 and extending in the axial direction 1. The armature shaft 36 is consequently supported centrally in the brush-holder 18 seated on the axial end 22. In FIG. 1 the armature shaft 36 protrudes outward through the brush-holder 18 in the axial direction 1. The brushes 12 are oriented radially with respect to the armature shaft 36, so that the brushes 12 are able to cooperate with a commutator which is supported on the armature shaft 36. However, an embodiment is possible in which the armature shaft 36 terminates in the brush-holder 18 and consequently does not protrude from the brush-holder 18. In addition, it is possible to arrange a brush-holder 18 within the field frame 240, so that the brush-holder 18 is covered in its entirety in the circumferential direction by the field frame 240.

The embodiment in FIG. 1 shows a brush-holder 18, the outer edge 20 of which is partially aligned with an outer contour 26 of the axial end 22. An appendage 30 is arranged radially outside the housing 24 which appendage is constructed as a plug socket 300. The plug socket 300 extends outward in the radial direction 2, proceeding from the contour 26 of the housing 24. In addition, the plug socket 300 extends in the radial direction 2 toward the field frame 240. The plug socket 300 includes two contact pins 32. It is possible to arrange a plurality of contact pins in the plug socket 300. An interference-suppressing component 14, which is constructed as a capacitor 140, is connected to the two contact pins 32 in parallel. It is possible to arrange several interference-suppressing components 14 on the appendage 30. It is also conceivable to arrange a large number of appendages 30 which each include one and/or several interference-suppressing components 14. The electrical contacting of the contact pins 32 with the capacitor 140 takes place on the axial side of the plug socket 300 that faces toward the bearing seat 34. Consequently the capacitor 140 is arranged on the plug socket 300 in an opposing manner with respect to the slide-in opening of the plug socket 300 with the free pin ends. The contact pins 32 are contacted on their rear region by the interference-suppressing component 14. The brush-holder 18 exhibits a base plate at right angles to the rotor shaft, which extends into the plug socket 300. The capacitor 140 is arranged on the base plate through which the axially opposing ends of the contact pins 32 have been guided. The brushes 12 are electrically connected to the contact pins 32 by stamped sheet-metal strips 33. Instead of the stamped sheet-metal strips 33, it is also possible to use a stranded conductor, a wire and/or a printed circuit board with conductor tracks for the electrical contacting between brush pair 12 and contact pins 32. Moreover, it is also conceivable to contact the interference-suppressing component 14 with the stamped sheet-metal strips 33 outside the housing 24, respectively the field frame 240. In addition, yet further components such as, for example, thermal switches, capacitors, for example of the Class Y or Class X type, chokes can be arranged on the brush-holder 18. The contacting with the contact pins 32 or with the stamped sheet-metal strips 33 can be effected in this case by soldering and/or welding and/or crimping. The plug socket 300 is integrally formed with the brush-holder 18. In this case the plug socket 300 and the brush-holder 18 have been injection-molded in a common method step. The interference-suppressing component 14 may in this case also have been encapsulated by the plastic material of the brush-holder 18 and of the plug socket 300 by injection molding. The stamped sheet-metal strips 33 may have been mounted on the brush-holder 18 as inserts. It is also possible that the stamped sheet-metal strips 33 have been encapsulated by the brush-holder and the plug socket 300 by injection molding.

Let it be noted that diverse possibilities for combination of the individual features amongst themselves are possible as regards the exemplary embodiments presented in the figure and in the description. Moreover, the electric machine 10 with a brush-holder 18 according to the invention finds use as, for example, a window regulator, sunroof, trunk-hatch drive, seat-adjusting drive or servo drive of a manual transmission. Besides this application, application in other technical fields is also possible.

1. An electric machine (10) with brushes (12) for commutation and with an electrical interference-suppressing component (14), wherein the brushes (12) are arranged in an annular brush-carrier (18), wherein the brush-carrier (18) rests on an axial end (22) of a housing part (24) of the electric machine (10), wherein the interference-suppressing component (14) is arranged radially outside the housing (24) and the brush-carrier (18) has an appendage (30) extending radially outward, so that the appendage (30) extends outside the housing (24), and wherein the interference-suppressing component (14) is arranged on the appendage (30).

2. The electric machine (10) as claimed in claim 1, characterized in that the interference-suppressing component (14) includes an individual capacitor (140).

3. The electric machine (10) as claimed in claim 1, characterized in that the appendage (30) includes a plug socket (300) with contact pins (32) which are electrically connected to the brushes (12) by stamped sheet-metal strips (33), wherein the interference-suppressing component (14) is connected to the contact pins (32) in parallel.

4. The electric machine (10) as claimed in claim 1, characterized in that the interference-suppressing component (14) is contacted with at least one of the contact pins (32) and the stamped sheet-metal strips (33) by material closure by means of soldering or welding, and/or non-positively by means of crimping.

5. The electric machine (10) as claimed in claim 1, characterized in that the appendage (30) is integrally formed with the brush-carrier (18).

6. The electric machine (10) as claimed in claim 1, characterized in that the interference-suppressing component (14) is encapsulated in the appendage (30) by injection molding.

7. The electric machine (10) as claimed in claim 1, characterized in that the brush-carrier (18) is a plastic injection-molded part.

8. The electric machine (10) as claimed in claim 1, characterized in that the brush-carrier (18) includes a bearing seat (34) for an armature shaft (36).

9. (canceled)

10. The electric machine (10) as claimed in claim 1, characterized in that said housing part is a field frame (240).

11. The electric machine (10) as claimed in claim 1, characterized in that the interference-suppressing component (14) is contacted with at least one of the contact pins (32) and the stamped sheet-metal strips (33) non-positively by means of crimping.

12. The electric machine (10) as claimed in claim 11, characterized in that the interference-suppressing component (14) is also contacted with at least one of the contact pins (32) and the stamped sheet-metal strips (33) by material closure by means of soldering or welding.

13. The electric machine (10) as claimed in claim 1, characterized in that the appendage (30) is integrally formed with the brush-carrier (18) and is an injection-molded part.

14. An adjusting drive in an automobile, the adjusting drive comprising the electric machine as claimed in claim 1.

15. The adjusting drive as claimed in claim 14, wherein the adjusting drive is a window regulator, sunroof drive, trunk-hatch drive, seat-adjusting drive and/or drive of a manual transmission.
